(19) United States
(12) Patent Application Publication
(10) Pub. No.: US 2025/0296037 A1
(43) Pub. Date: Sep. 25, 2025

(54) MEMBRANE CONTACTOR WITH BUBBLER

(71) Applicant: Honeywell International Inc., Charlotte, NC (US)

(72) Inventors: Phoebe Henson, Glendale, AZ (US); Rebecca Kamire, Buffalo Grove, IL (US); David Loeffelholz, Long Beach, CA (US); Stephen Yates, South Barrington, IL (US); Eric D. Pope, Glendale, AZ (US); Emir Rahislic, Chicago, IL (US)

(21) Appl. No.: 18/612,916

(22) Filed: Mar. 21, 2024

(51) Int. Cl. B01D 53/18; B01D 53/14; B01D 69/08; B01F 23/231

(52) U.S. Cl. CPC B01D 53/185; B01D 53/1425; B01D 53/1475; B01D 69/08; B01F 23/2312; B01D 2252/30; B01D 2257/504; B01D 2257/80; B01D 2258/06; B01D 2259/4575

(57) ABSTRACT

A liquid sorbent system includes a membrane contactor and a bubbler. The membrane contactor is configured to absorb one or more contaminants into or desorb one or more contaminants from a liquid sorbent. The membrane contactor includes a contactor housing and one or more hollow fiber membranes positioned in the contactor housing. The contactor housing is configured to receive the liquid sorbent at a liquid inlet and discharge liquid sorbent at a liquid outlet. The bubbler is configured to generate bubbles in the liquid sorbent upstream of the liquid outlet.

### GOVERNMENT RIGHTS

This invention was made with Government support under Grant Contract Number 80MSFC18C0045 awarded by National Aeronautics and Space Administration (NASA) Marshall Space Flight Center. The Government has certain rights in the invention.

### TECHNICAL FIELD

The present disclosure relates to membrane contactors.

### BACKGROUND

Membrane contactors transfer gases into or from a liquid medium. For example, membrane contactors may be used to absorb contaminants, such as carbon dioxide, from a gas stream into the liquid medium and process the liquid medium to recharge the liquid medium or recover the removed contaminants. A removal efficiency of a membrane contactor may be related to a surface area of membranes of the membrane contactor and fluid conditions at an interface between the membranes and the liquid medium. For example, fluid conditions that are not favorable to transfer of the contaminant from the gas stream into the liquid medium may result in a membrane contactor having higher surface area, and thus larger size, to compensate for the relatively low mass transfer of contaminants across the interface.

### SUMMARY

The disclosure describes systems and techniques for increasing mass transfer across a gas-liquid interface of a membrane contactor. The membrane contactor includes one or more hollow fiber membranes, and either scrubs contaminants from a gas stream by absorbing the contaminants into a liquid sorbent or strips contaminants into a gas stream by desorbing the contaminants from the liquid sorbent. Flow of the liquid sorbent through or around hollow fibers of the hollow fiber membrane may be laminar, such that liquid sorbent loaded with the contaminants may remain near the gas-liquid interface and create a local concentration gradient. To increase agitation at the gas-liquid interface, a bubbler generate bubbles in the liquid sorbent, thereby increasing mass transfer of contaminants into and/or out of the liquid sorbent. As a result, membrane contactors described herein may have a reduced surface area of membranes, and correspondingly a reduced size, for a particular contaminant removal rate than membrane contactors that do not incorporate a bubbler.

In some examples, the disclosure describes a liquid sorbent system that includes a membrane contactor and a bubbler. The membrane contactor is configured to absorb one or more contaminants into or desorb one or more contaminants from a liquid sorbent. The membrane contactor includes a contactor housing and one or more hollow fiber membranes positioned in the contactor housing. The contactor housing is configured to receive the liquid sorbent at a liquid inlet and discharge liquid sorbent at a liquid outlet. The bubbler is configured to generate bubbles in the liquid sorbent upstream of the liquid outlet.

In some examples, the disclosure describes a method for absorbing one or more contaminants into or desorbing one or more contaminants from a liquid sorbent. The method includes flowing, by a membrane contactor, the liquid sorbent through one or more hollow fiber membranes. The membrane contactor includes a contactor housing and the one or more hollow fiber membranes positioned in the contactor housing. The contactor housing is configured to receive the liquid sorbent at a liquid inlet and discharge liquid sorbent at a liquid outlet. The method further includes generating, by a bubbler, bubbles in the liquid sorbent upstream of the liquid outlet.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a block diagram illustrating an example contaminant removal system for removing contaminants from a cabin air stream using liquid sorbents.

FIG. 1B is a block diagram illustrating an example scrubber for removing contaminants from a cabin air stream.

FIG. 1C is a block diagram illustrating an example stripper for removing contaminants from a liquid sorbent.

FIG. 2A is a cross-sectional side view diagram illustrating an example liquid sorbent system that includes a bubbler at least partially positioned within a membrane contactor.

FIG. 2B is a cross-sectional side view diagram illustrating an example liquid sorbent system that includes a bubbler upstream of a membrane contactor.

FIG. 2C is a cross-sectional side view diagram illustrating a gas-liquid interface of an example membrane contactor.

FIG. 2D is a flowchart of an example method for removing a contaminant using a liquid sorbent system that includes a membrane contactor and a bubbler.

FIG. 3A is a schematic diagram illustrating an example assembly that includes a sparger for generating bubbles using a non-condensable gas.

FIG. 3B is a schematic diagram illustrating an example assembly that includes a sparger for generating bubbles using a condensable gas.

FIG. 3C is a schematic diagram illustrating an example assembly that includes a membrane contactor for generating bubbles using a condensable gas.

FIG. 3D is a schematic diagram illustrating an example assembly that includes a metering valve for generating bubbles using water in a liquid sorbent mixture.

FIG. 4 is a schematic diagram illustrating an example contaminant removal system for removing contaminants from a cabin air stream using liquid sorbents.

### DETAILED DESCRIPTION

The disclosure describes systems and techniques for increasing mass transfer across a gas-liquid interface of a membrane contactor. Membrane contactors described herein may be utilized as scrubbers and/or strippers in contaminant removal systems as part of an environmental controls system (ECS), such as in spacecraft, aircraft, watercraft, and the like. In some examples, contaminant removal systems may be used in an ECS of a resource-limited environment, such as a passenger cabin of a spacecraft, in which carbon dioxide and water may be recycled to produce oxygen gas, water, methane, hydrogen gas, and a variety of other compounds used in life support systems. Such resource-limited environments may be particularly suited for a contaminant removal system that includes components that use low amounts of power and have extended service lives to reduce overall weight, power consumption, and maintenance load.

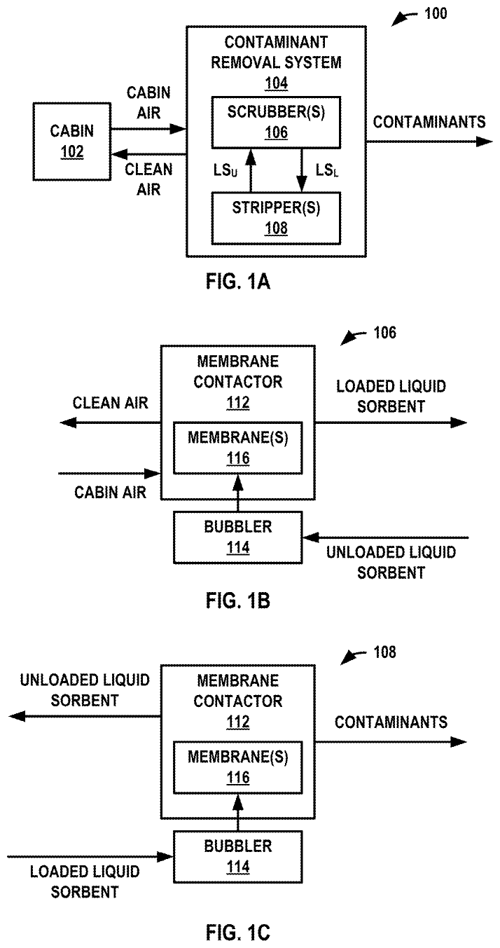

FIG. 1A is a block diagram illustrating an example contaminant removal system 104 for removing contaminants from a cabin air stream using liquid sorbents. Contaminant removal system 104 is configured to remove contaminants from a cabin 102. Cabin 102 may be a controlled environment, such as an aircraft cabin, spacecraft cabin, watercraft cabin, or the like, and contaminants removed from cabin 102 may include, but are not limited to, carbon dioxide, water, hydrocarbons, permanent gases, or the like. In the example of FIG. 1A, cabin 102 is a cabin of a closed-loop system, such as a spacecraft cabin or submarine cabin, in which components of a cabin air stream from cabin 102, such as carbon dioxide and water, may be removed within contaminant removal system 100, allowing a purified supply air stream to be generated and carbon dioxide and water to be recovered. However, in other examples, cabin 102 may be a cabin of an open-loop system, such as an aircraft cabin, in which components of a cabin air stream may be removed to generate a purified supply air stream with only partial or no subsequent recovery of the contaminants.

Contaminant removal system 104 is configured to remove one or more contaminants from the cabin air stream using a liquid sorbent. A liquid sorbent may include any liquid configured to absorb and desorb a gaseous species. Liquid sorbents may be water soluble, hygroscopic (i.e., capable of absorbing moisture from the air), capable of absorbing or desorbing contaminants in response to a change in solubility driven by a change in temperature, and/or capable of releasing water by evaporation, such as by elevating the temperature or reducing the water partial pressure. In some examples, the liquid sorbent may be an ionic liquid sorbent. Ionic liquid sorbents may be salts that are generally comprised of an anion and an organic cation. These salts may be liquid at their temperature of use, have effectively zero vapor pressure, be generally nontoxic, and/or have sufficient stability to resist deterioration. In some examples, ionic liquid sorbents may contain relatively large organic cations and any of a variety of anions, which may be tailored to obtain desired characteristics, such as characteristics that improve absorption of the particular contaminant under operating conditions of carbon dioxide removal system 104. The liquid sorbent may be selected for a variety of properties related to contact with a hydrophobic membrane and absorption of carbon dioxide including, but not limited to, a high capacity for carbon dioxide, a low viscosity, and a high stability. A variety of ionic liquid sorbents may be used including, but not limited to, imidazolium salts, such as 1-ethyl-3-methylimidazolium (EMIM) acetate (Ac).

Liquid sorbents may be used with membrane separators, such as scrubber(s) 106 and stripper(s) 108, that contact an air stream with the liquid sorbent across one or more hydrophobic porous membranes. In the example of FIG. 1A, contaminant removal system 104 includes at least one scrubber 106 and at least one stripper 108. Scrubber 106 and/or stripper 108 may include one or more membrane contactors configured to flow air on a first side and flow liquid sorbent on a second, opposite side. Scrubber 106 is configured to absorb carbon dioxide from the cabin air stream into the liquid sorbent and discharge a clean air stream having a lower concentration of carbon dioxide than the cabin air stream. Stripper 108 is configured to desorb carbon dioxide, and optionally other contaminants, from the liquid sorbent into a contaminant stream for discharge, storage, or further processing. A liquid sorbent loop circulates a loaded liquid sorbent (LS_{L}) stream from scrubber 106 to stripper 108 and an unloaded liquid sorbent (LS_{U}) stream from stripper 108 to scrubber 106.

Hollow fiber membranes of membrane contactors, such as scrubber 106 and stripper 108, include very small diameter fibers packed into bundles having small interstitial spaces. As a result, flow of liquid sorbent on either a tube or shell side of the hollow fibers is laminar, such that liquid sorbent loaded with the contaminants may remain near the gas-liquid interface and reduce a local concentration gradient. For example, a Reynolds number of flow of liquid sorbent within the hollow fibers may be less than about 2300 (e.g., laminar flow), such as less than about 1500 (e.g., slug flow, or less than about 1 (e.g., creeping flow). To increase agitation at the gas-liquid interface, liquid sorbent systems described herein, such as contaminant removal system 104, include a bubbler upstream of or incorporated into the membrane contactors. As a result, membrane contactors described herein may have a reduced surface area of membranes, and correspondingly a reduced size, for a particular contaminant removal rate than membrane contactors that do not incorporate a bubbler.

In some examples, a bubbler may be used in conjunction with a membrane contactor to scrub contaminants from a cabin air stream into a liquid sorbent. FIG. 1B is a block diagram illustrating an example scrubber 106 for removing contaminants from a cabin air stream. Scrubber 106 includes a membrane contactor 112 and a bubbler 114. Membrane contactor 112 includes one or more hollow fiber membranes 116 that permit one or more contaminants to migrate across hollow fibers between the cabin air stream and the liquid sorbent. Membrane contactor 112 is configured to receive the cabin air stream from cabin 102, absorb contaminants into a liquid sorbent through membranes 116, and discharge a clean air stream back to cabin 102.

To improve mass transfer of contaminants into the liquid sorbent, scrubber 106 includes bubbler 114 upstream of or incorporated into membrane contactor 112. Bubbler 114 is configured to receive unloaded liquid sorbent, generate bubbles in the liquid sorbent, and discharge aerated liquid sorbent to membrane contactor 112. Without being limited to any particular theory, the bubbles generated in the liquid sorbent may improve mixing of the liquid sorbent near the gas-liquid interface at the pores of membranes 116, thereby reducing a local concentration of contaminants and increasing a concentration gradient of the contaminants across membranes 116.

Membrane contactor 112 is configured to receive the sparged unloaded liquid sorbent, transfer contaminants into the sparged liquid sorbent at a relatively high mass transfer rate, and discharge loaded liquid sorbent. Due to the increased agitation of the aerated liquid sorbent, a lower surface area of membranes 116 may be required to achieve a particular contaminant removal rate from the cabin air stream into the liquid sorbent.

In some examples, a bubbler may be used in conjunction with a membrane contactor to strip contaminants from a liquid sorbent into a contaminant stream. FIG. 1C is a block diagram illustrating an example stripper 108 for removing contaminants from a liquid sorbent. Stripper 108 includes membrane contactor 112 having one or more hollow fiber membranes 116 and bubbler 114 upstream of or incorporated into membrane contactor 112. Bubbler 114 is configured to receive loaded liquid sorbent, generate bubbles in the liquid sorbent, and discharge aerated liquid sorbent into membrane contactor 112. The bubbles generated in the liquid sorbent may improve mixing of the liquid sorbent near the gas-liquid interface at the pores of membranes 116, thereby increasing a local concentration of contaminants in the liquid sorbent near the pores of membranes 116 and increasing a concentration gradient of the contaminants across membranes 116.

Membrane contactor 112 is configured to receive the aerated unloaded liquid sorbent, transfer the contaminants from the aerated liquid sorbent at a relatively high mass transfer rate, and discharge unloaded liquid sorbent. Due to the increased agitation of the aerated liquid sorbent, a lower surface area of membranes 116 may be required to achieve a particular contaminant removal rate from the cabin air stream into the liquid sorbent. Stripper 108 is fluidically coupled to a vacuum or sweep gas stream, and is configured to discharge the contaminants as the contaminant stream for venting, storage, or further processing.

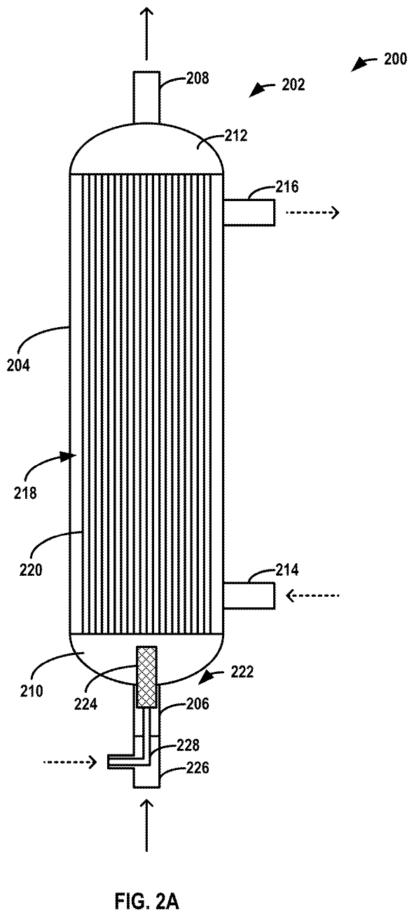

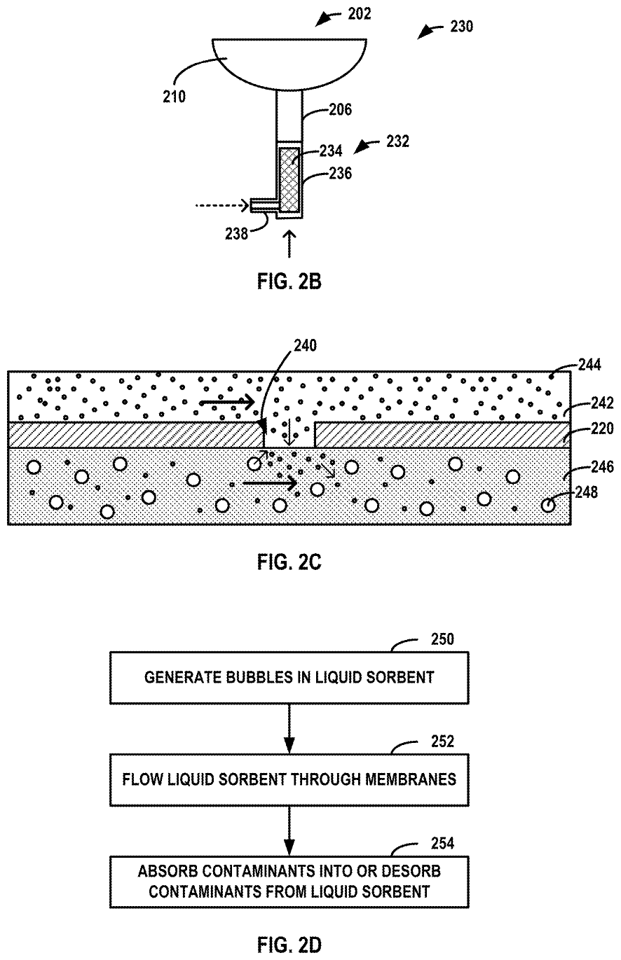

Liquid sorbent systems described herein may incorporate bubblers into or with membrane contactors in a variety of ways and configurations. FIG. 2A is a cross-sectional side view diagram illustrating an example liquid sorbent system 200 that includes a membrane contactor 202 and a bubbler 222 incorporated into membrane contactor 202.

Membrane contactor 202 is configured to absorb one or more contaminants into or desorb one or more contaminants from a liquid sorbent. In the example of FIGS. 2A-2D, membrane contactor 202 will be described with respect to absorption of contaminants into the liquid sorbent (e.g., a scrubber). However, in other examples, membrane contactor 202 may be configured to desorb contaminants from liquid sorbent (e.g., a stripper).

Membrane contactor 202 includes a contactor housing 204. Contactor housing 204 may be a cylindrical module or other vessel that includes a volume for enclosing one or more hollow fiber membranes 218. Contactor housing 204 includes a liquid inlet 206 fluidically coupled to an inlet plenum 210 and a liquid outlet 208 fluidically coupled to an outlet plenum 212. Liquid inlet 206 is configured to receive liquid sorbent, while liquid outlet 208 is configured to discharge liquid sorbent. Contactor housing also include two gas ports 214 and 216 configured to fluidically couple to a gas stream, such as a cabin air stream, a sweep gas stream, or a contaminant stream. In the example of FIG. 2A in which membrane contactor 202 operates as either a scrubber or as a stripper with a sweep gas stream, port 214 is configured to operate as a gas inlet and port 216 is configured to operate as a gas outlet. However, in examples in which membrane contactor operates as a stripper without a sweep gas stream, both ports 214 and 216 may operate as gas outlets coupled to a vacuum.

Membrane contactor 202 includes one or more hollow fiber membranes 218 positioned in contactor housing 204. Hollow fiber membranes 218 are filled with parallel or woven hollow porous fibers 220. Dimensions of these hollow fibers 220 could be less than about 3 mm, and the pore dimension could be less than about 2 microns. The high surface area of hollow fiber membrane 218 enables a high mass transfer of contaminant gases, such as carbon dioxide and water, into the respective liquid sorbent using a relatively small system volume and weight. The material of hollow fibers 220 can be selected such that the liquid sorbent does not wet the pores, and the trans-membrane pressure is kept sufficiently low to prevent pore penetration by the liquid. As a result, membrane contactor 202 may ensure that the liquid sorbent and gas stream do not need further separation, such that liquid sorbent system 200 incorporating membrane contactor 202 may act in a gravity-independent way without the use of moving parts. Fiber materials may include, but are not limited to, hydrophobic materials such as polypropylene, polyvinylidene fluoride, polysulfone, polyimide, polytetrafluoroethylene (PTFE), and the like. In some examples, a coating may be applied to reduce liquid flow through the pores. Coatings that may be used include, but are not limited to, PTFE, a crosslinked siloxane, perfluorinated polymers, functionalized nanoparticles, and the like to prevent liquid flow through the pores. While described in FIG. 2A as flowing through a “tube” side, liquid sorbent flow can be either on the “tube” side or the “shell” side, while gas is flowed on the opposite side.

Bubbler 222 is configured to generate bubbles in the liquid sorbent upstream of liquid outlet 208, such that at least a portion of the aerated liquid sorbent contacts surfaces of membrane 218 prior to being discharged from membrane contactor 202. In the example of FIG. 2A, bubbler 222 includes one or more spargers 224, a gas stream junction 226, and a gas stream conduit 228. Gas stream junction 226 is configured to couple to liquid inlet 206, receive the liquid sorbent, and receive a bubbler gas stream. Gas stream conduit 228 is configured to receive the bubbler gas stream in gas stream junction 226 and deliver the bubbler gas stream to sparger 224. While illustrated as being separate from liquid inlet 206, in some examples, gas stream junction 226, gas stream conduit 228, and liquid inlet 206 are combined into a same unit.

Sparger 224 (also known as an aerator or diffuser) is configured to receive the gas stream from gas stream conduit 228 and generate bubbles in the liquid sorbent using the gas stream. A variety of spargers may be used including, but not limited to, a porous sparger, an orifice sparger, a nozzle sparger, or any other type of sparger. In some examples, sparger 224 is a porous sparger. A porous sparger may be formed from a porous material, such as sintered metal or ceramic, that includes interconnected pores. When the gas stream is applied to one side of the porous sparger, the gas diffuses through the pores and emerges as fine bubbles on the other side contacting the liquid sorbent. The porous structure of the porous sparger uniformly distributes the gas, creating a high surface area for efficient gas-liquid interaction. As the liquid sorbent flows through hollow fibers 220, the bubbles promote mixing at the gas-liquid interface of portions of membrane 218 downstream of sparger 224.

Sparger 224 may be positioned at any position within contactor housing 204 or liquid tubing immediately upstream of contactor housing 204, such that liquid sorbent may be aerated prior to contacting some portion of membrane 218. In the example of FIG. 2A, a portion of sparger 224 is positioned in liquid inlet 206 (“in line”), while another portion of sparger 224 is positioned in inlet plenum 210 (“in tank”). However, sparger 224 may be positioned at other axial or radial positions within contactor housing 204 upstream of liquid outlet 208. For example, while not shown in the example of FIG. 2A, an additional sparger may be positioned at an intermediate axial position between liquid inlet 206 and liquid outlet 208, such that bubbles may be introduced into the liquid sorbent to compensate for reduced aeration as the liquid sorbent travels through membranes 218.

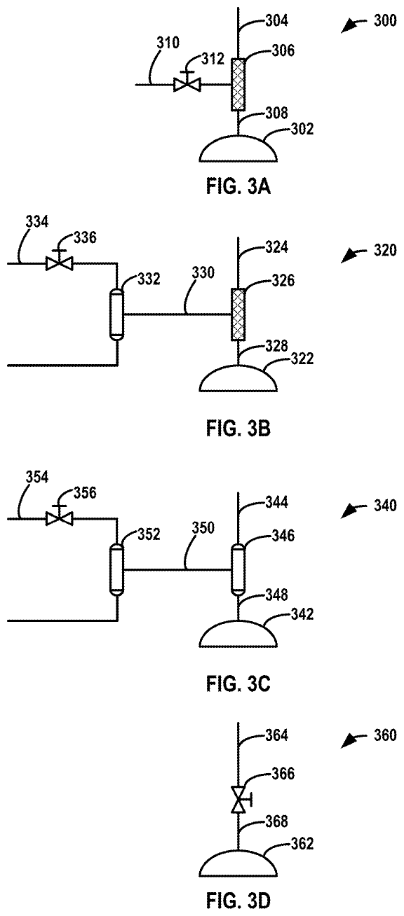

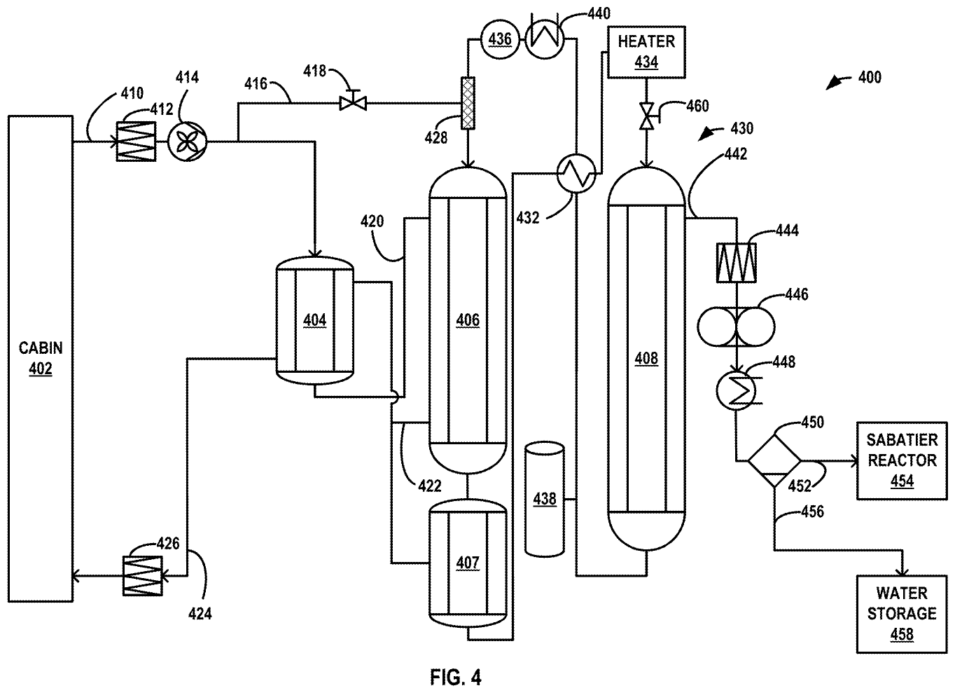

While bubbler 222 has been described with respect to bubbles produced by sparger 224, in other examples, bubbler 222 may include other devices that generate bubbles to increase agitation of the liquid sorbent. For example, as will be described further in FIGS. 3D and 4, bubbler 222 may include a metering valve or other pressure reducing device for generating bubbles from water in a liquid sorbent mixture. Such a pressure reducing device may be configured to generate bubbles in a fluid stream by reducing a pressure of the fluid stream to form a bubbled stream. The reduction in pressure may cause at least a portion of the water to evaporate and form water vapor bubbles.

The bubbles generated by bubbler 222 increase agitation, and correspondingly mixing, of the liquid sorbent while the liquid sorbent flows through fibers 220. Without being limited to any particular theory, FIG. 2C is a cross-sectional side view diagram illustrating a gas-liquid interface of hollow fiber 220 of an example membrane contactor. A gas stream 242 flowing on a shell side of fiber 220 includes a relatively high concentration of contaminants 244, while a liquid sorbent 246 flowing through a tube side of fiber 220 includes a relatively low concentration of contaminants 244. Contaminants 244 may transfer across fiber 220 of membrane 218 through pore 240 into liquid sorbent 246, while liquid sorbent 246 may remain on the tube side of fiber 220 due to a hydrophobicity of fiber 220. The flow of liquid sorbent 246 may be laminar due to a small diameter of fiber 220 that restricts turbulent flow, even at very high flow rates. As a result, even though a concentration of contaminants 244 may be substantially lower in liquid sorbent 246, a local concentration of contaminants 244 may be relatively high near pore 240, thereby reducing a concentration gradient of contaminants 244.

However, inclusion of bubbles 248 in liquid sorbent 246 may increase agitation of liquid sorbent 246 near pore 240. For example, a pressure of liquid sorbent 246 may be maintained higher than a pressure of gas stream 242, such that bubbles 248 may migrate to pore 240 and into gas stream 242. This migration may increase mixing near pore 240, thereby lowering a concentration of contaminant 244 near pore 240. This migration may also fill pores with gas, since liquid sorbent 246 in pore 240 may be stagnant and diffusion of gases through this stagnant liquid may be slow. If pushing air bubbles through pore 240 clears out any liquid sorbent, then more effective mass transfer may result. As another example, presence of bubbles 248 may provide bulk mixing throughout liquid sorbent 246, including near pore 240, thereby lowering a concentration of contaminant 244 near pore 240.

Referring back to FIG. 2A, to generate bubbles having a relatively small size, sparger 224 may include pores having a small size. A pore size may be related to a pressure drop across sparger 224, such that sparger 224 may be configured to produce bubbles that sufficiently agitate the liquid sorbent without requiring substantial pressurizing equipment. For example, sparger 224 may be configured to generate bubbles using a portion of a pressurized process gas stream, such as a portion of the cabin air stream, that is pressurized in the course of flowing the cabin air stream through the liquid sorbent system. In some examples, a pressure drop across sparger 224 is less than a pressure drop across a shell side of membrane 218, such that a same gas stream introduced to the shell side of membrane 218 may be used as a bubbler gas stream. In other examples, a supplemental pressure source may be used to increase a pressure of the gas stream.

In the example of FIG. 2A, sparger 224 is at least partially positioned within contactor housing 204. However, in other examples, bubblers may include a sparger that is positioned external to a membrane contactor. FIG. 2B is a cross-sectional side view diagram illustrating an example liquid sorbent system 230 that includes a bubbler 232 upstream of membrane contactor 202. For simplicity, only a portion of membrane contactor 202 of FIG. 2A near liquid inlet 206 and inlet plenum 210 is illustrated. Bubbler 232 includes one or more spargers 234, a gas stream junction 236, and a gas stream conduit 238, which may be operably similar to sparger 224, gas stream junction 226, and gas stream conduit 228 of FIG. 2A. However, bubbler 232 may be external of membrane contactor 202 and fluidically coupled to liquid inlet 206, such that bubbles are generated upstream of membrane contactor 202. As a result, bubbler 232 may be configured to retrofit an existing membrane contactor 202 with increased agitation without substantially modifying a design of membrane contactor 202.

FIG. 2D is a flowchart of an example method for absorbing one or more contaminants into or desorbing one or more contaminants from a liquid sorbent using a liquid sorbent system. The example method of FIG. 2D will be described with respect to liquid sorbent system 200 of FIG. 2A; however, other liquid sorbent systems, such as liquid sorbent systems that desorb, rather than absorb, contaminants into a liquid sorbent, may use the example method of FIG. 2D. The method of FIG. 2D includes generating, by bubbler 222, bubbles in the liquid sorbent upstream of liquid outlet 208 (250). For example, a controller may operate a valve to control a flow rate of a gas stream through gas stream conduit 228 to generate a particular number or size of bubbles in the liquid sorbent. Parameters of the gas stream that may control parameters of the bubbles include a flow rate of the liquid sorbent, a pressure of the liquid sorbent, and a temperature of the liquid sorbent, while parameters of the bubbles that may be controlled include a bubble size, a bubble quantity, and a degree of mixing induced by the bubbles. The method of FIG. 2D includes flowing, by membrane contactor 202, a liquid sorbent through one or more hollow fiber membranes 218 (252). For example, the controller may operate a pump or other pressure device in a liquid sorbent to flow the liquid sorbent through liquid inlet 206 and contacting sparger 224 to transport the liquid sorbent having bubbles through membranes 118. The method of FIG. 2D includes absorbing, by membrane contactor 202, contaminants into or desorbing contaminants from the liquid sorbent (254). For example, in FIG. 2A, the contaminants may migrate through pores of membranes 218 into the liquid sorbent. Due to the increased agitation in the liquid sorbent caused by the bubbles, a local concentration gradient near the pores may be higher, thereby increasing mass transfer of the contaminants into the liquid sorbent.

Contaminant removal systems described herein may generate bubbles using a variety of different methods for different membrane contactors, such as scrubbers or strippers. FIG. 3A is a schematic diagram illustrating an example assembly 300 for a membrane contactor 302 that includes a sparger 306 for generating bubbles using a non-condensable gas. Membrane contactor 302 may be a scrubber or a stripper. For example, with respect to a stripper, if a purity of the contaminant stream from the stripper is not important, the bubbled gas may be any non-condensable gas that will not be fully absorbed by the liquid sorbent. Sparger 306 is configured to receive a fluid stream 304 and generate bubbles in fluid stream 304 using a gas stream 310 to form bubbled stream 308. A control valve 312 may control flow of gas stream 310.

FIG. 3B is a schematic diagram illustrating an example assembly for a stripper 322 that includes a sparger 326 for generating bubbles using a condensable gas, such as water vapor. For example, if a purity of the contaminant stream removed by stripper 322 is important, using water vapor or another condensable gas as the bubbling gas may permit separation of the bubbling gas from the target stripped gas. Sparger 326 is configured to receive a fluid stream 324 and generate bubbles in fluid stream 324 using a gas stream 330 to form bubbled stream 328. Gas stream 330 may be discharged from a shell side of a membrane contactor 332. A hot water stream 334 may flow through a tube side of membrane contactor 332, such that hot water may evaporate and migrate to the shell side of membrane contactor 332. A control valve 336 may control flow of hot water stream 334 and, correspondingly, flow of gas stream 330.

FIG. 3C is a schematic diagram illustrating an example assembly 340 for a stripper 342 that includes a membrane contactor 346 for generating bubbles using a condensable gas, such as water vapor. Membrane contactor 346 is configured to receive a fluid stream 344 through a tube side and a gas stream 350 on a shell side. Gas from gas stream 350 may migrate across a membrane into fluid stream 344 to form bubbled stream 348. Gas stream 350 may be discharged from a shell side of a membrane contactor 352. A hot water stream 354 may flow through a tube side of membrane contactor 352, such that hot water may evaporate and migrate to the shell side of membrane contactor 352. A control valve 356 may control flow of hot water stream 354 and, correspondingly, flow of gas stream 350.

FIG. 3D is a schematic diagram illustrating an example assembly 360 for a stripper 362 that includes a metering valve 366 for generating bubbles from water in a liquid sorbent mixture. Metering valve 366 is configured to receive a fluid stream 364 that includes water. Metering valve 366 is configured to generate bubbles in fluid stream 364 by reducing a pressure of fluid stream 364 to form bubbled stream 368. The reduction in pressure may cause at least a portion of the water to evaporate and form water vapor bubbles.

FIG. 4 is more detailed schematic diagram illustrating example contaminant removal system 400 for removing contaminants from a cabin air stream using liquid sorbents. In the example of FIG. 4, cabin 402 may be a cabin of a closed-loop system, such as a spacecraft cabin or submarine cabin, in which components of cabin air stream 410 from cabin 402, such as carbon dioxide and water, may be removed within contaminant removal system 400, allowing a purified rehumidified air stream 424 to be generated. In some examples, cabin air stream 410 may have a carbon dioxide concentration between about 1000 ppm and about 5000 ppm and/or a hydrocarbon concentration less than about 100 ppm. Rehumidified air stream 424 has a lower concentration of carbon dioxide than cabin air stream 410. For example, rehumidified air stream 424 may have a concentration of carbon dioxide that is about 25% to about 99% less than a concentration of carbon dioxide in cabin air stream 310, such as about 40% to about 95% less than the concentration of carbon dioxide in cabin air stream 310.

Contaminant removal system 400 includes a cabin air circuit (not labeled) configured to circulate cabin air between cabin 402 and a scrubber 406 via an optional membrane dehumidifier 404. In the example of FIG. 4, cabin air stream 410 includes a filter 412 configured to remove particulates from cabin air stream 410 prior to entry into membrane dehumidifier 404 and a blower 414 configured to draw cabin air into membrane dehumidifiers 404, while rehumidified air stream 424 includes a filter 426 configured to remove any leaked liquid sorbent and/or further filter clean air from rehumidified air stream 424 prior to entry into cabin 402.

Contaminant removal systems 400 includes a membrane dehumidifier 404. Membrane dehumidifier 404 is configured to return humidity from cabin air stream 410 to a decontaminated air stream 422 and discharge a dehumidified air stream 420 to scrubber 406. On one side, dehumidifier 404 is configured to receive cabin air stream 410 as a feed gas stream and discharge dehumidified air stream 420 to scrubber 406 having a lower humidity. As a result, dehumidified air from dehumidified air stream 420 may have a lower humidity than cabin air from cabin air stream 410. For example, dehumidified air stream 420 may have a humidity that is between about 0% and about 35% relative humidity. On an opposite side, dehumidifier 404 is configured to receive decontaminated air stream 422 from scrubber 406 and discharge rehumidified air to rehumidified air stream 424 having a higher humidity than decontaminated air stream 422. For example, rehumidified air stream 424 may have a humidity that is selected to maintain a humidity of cabin 402 between about 5% and about 75% relative humidity.

Contaminant removal system 400A includes liquid sorbent loop 430 configured to circulate liquid sorbent between scrubber 406 and stripper 408. For example, a pump 436 may pump unloaded liquid sorbent from stripper 408 into scrubber 406. Unloaded liquid sorbent may include unused liquid sorbent free of contaminants or regenerated liquid sorbent having a lower concentration of contaminants than the loaded liquid sorbent. In some examples, the unloaded liquid sorbent may be cooled by a cooler 440 prior to entry into scrubber 406. In some examples, the loaded liquid sorbent may be preheated by a heat exchanger 432 and/or heater 434 prior to entry into stripper 408. A liquid sorbent storage 438 may store liquid sorbent, such as in a relatively cool state.

Scrubber 406 is configured to absorb contaminants from dehumidified air stream 420 into the liquid sorbent and discharge decontaminated air stream 422 to membrane dehumidifier 404. On a gas phase side, scrubber 406 is configured to receive dehumidified air from dehumidified air stream 420 that includes contaminants, such as carbon dioxide and water, from cabin 402. Scrubber 406 includes one or more hollow fiber membranes, each configured to flow (e.g., provide or direct flow of) dehumidified air from dehumidified air stream 420 on a gas phase side (e.g., a tube side) of the respective membrane and flow the liquid sorbent on a liquid phase side (e.g., a shell side) of the membrane. Contaminants may pass through the membrane due to a concentration gradient between the dehumidified air and the liquid sorbent and become absorbed by the liquid sorbent, while the liquid sorbent may not substantially flow through the membrane. As a result, decontaminated air from decontaminated air stream 422 discharged from scrubber 406 may have a lower concentration of contaminants than dehumidified air from dehumidified air stream 420 received by scrubber 406. On a liquid phase side, scrubber 406 is configured to receive unloaded liquid sorbent. The unloaded second liquid sorbent may flow through scrubber 406 and absorb carbon dioxide and other gaseous contaminants from dehumidified air through the membrane(s) of scrubber 406. As a result, the loaded liquid sorbent discharged from scrubber 406 may have a higher concentration of carbon dioxide than the unloaded second liquid sorbent received by scrubber 406. Scrubber 406 may discharge the loaded liquid sorbent containing the carbon dioxide to stripper 408.

To improve mass transfer of contaminants into the liquid sorbent, contaminant removal system 400 includes bubbler 428 upstream of scrubber 406. Bubbler 428 is configured to generate bubbles in the unloaded liquid sorbent introduced into scrubber 406. In the example of FIG. 4, bubbler 428 is configured to receive a portion of cabin air stream 410 as bubbler gas stream 416. Flow of bubbler gas stream 416 may be controlled by a bubbler control valve 418 and, in some instances, a supplemental pressure source (not shown). For example, a liquid pressure in scrubber 406 may be higher than a gas pressure of gas stream 416 to avoid gas bubbling into the liquid sorbent with no way out. Bubbler 428 may not make sufficient bubbles if a pressure drop of gas through scrubber 406 is sufficiently low. In other examples, bubbler 428 may be configured to receive a portion of another system stream, such as product stream 452. For example, product stream 452 may have relatively dry, pressurized gas. Bubbler 428 is configured to discharge bubbler gas stream 416 into the liquid sorbent to generate the bubbles. For example, bubbler gas stream 416 may be pressurized by blower 414 sufficiently to overcome a pressure drop across a sparger of bubbler 428. As a result, scrubber 406 may absorb contaminants at a higher rate for a given surface area of membrane, thereby reducing an overall size of scrubber 406.

In some examples, contaminant removal system 400 may include a degasser 407 downstream of scrubber 406. Degasser 407 may be a membrane contactor similar in operation to scrubber 406. Degasser 407 may be configured to degas the liquid sorbent by removing at least a portion of any bubbles that may remain in the unloaded liquid sorbent discharged from scrubber 406. For example, scrubber 406 may not remove all the bubbles in the unloaded liquid sorbent, which may otherwise be removed at stripper 408. Degasser 407 may remove the bubbles from the liquid sorbent prior to the liquid sorbent being heated by heat exchanger 432 and heater 434 and discharged into stripper 487. Such additional removal may reduce or avoid extra air oxidizing the liquid sorbent upon heating, air accumulating and building pressure in liquid sorbent loop 430, and/or air desorbing into contaminant stream 442.

Stripper 408 is configured to desorb the carbon dioxide from the liquid sorbent into contaminant stream 442. On a liquid phase side, stripper 408 is configured to receive loaded liquid sorbent from scrubber 406 and desorb contaminants from the loaded liquid sorbent. Stripper 408 includes one or more hollow fiber membranes, each configured to flow the loaded liquid sorbent on one side (e.g., a shell side) of the membrane and contaminated air to contaminant stream 442 on an opposite side (e.g., a tube side) of the membrane. Contaminants may flow across fibers of the membrane due to a concentration gradient, while the liquid sorbent may not substantially flow across the fibers of the membrane. As a result, unloaded liquid sorbent discharged from stripper 408 may have a lower concentration of contaminants than the loaded liquid sorbent received by stripper 408. On a gas phase side, stripper 408 is configured to discharge the contaminants in contaminant stream 442. Contaminant stream 442 may be continuously removed from stripper 408 to assist migration of the contaminants from the loaded liquid sorbent into contaminant stream 442.

To improve mass transfer of contaminants from the liquid sorbent, contaminant removal system 400 includes bubbler 460 upstream of stripper 408. Bubbler 460 is configured to generate bubbles in the loaded liquid sorbent introduced into stripper 408. In the example of FIG. 4, bubbler 460 is configured to receive the loaded liquid sorbent and generate water vapor bubbles from water in the liquid sorbent mixture. For example, bubbler 460 may be a metering valve configured to reduce a pressure of the loaded liquid sorbent below a vapor pressure of water in the liquid sorbent mixture. As a result, stripper 408 may desorb contaminants at a higher rate for a given surface area of membrane, thereby reducing an overall size of stripper 408.

In operation, bubbler 460, which may include a metering valve or other pressure reducing device, may be positioned before stripper 408 to draw down a pressure of the liquid sorbent in stripper 408 below atmospheric pressure. By generating a vacuum on a liquid sorbent side of stripper 408, more carbon dioxide or other contaminants may be removed from solution for a particular contact area of stripper 408. If a pressure of stripper 408 is lowered enough, steam bubbles will form in the liquid sorbent mixture downstream of bubbler 460.

To get carbon dioxide or other contaminants to exit the liquid sorbent into the bubbles, a pressure of the contaminants may be below a partial pressure of the water vapor gas phase, such as less than about 5 torr partial pressure for carbon dioxide. To get water vapor to evaporate out of the liquid sorbent mixture and form the bubble phase (and/or remain as bubbles in the liquid vs absorbing into the liquid), a pressure of the liquid sorbent mixture may be from about 0.2 to about 0.8 psia at 55° C., based on the liquid sorbent capacity for water. For example, a pressure of water at 55° C. may be reduced down to less than or equal to about 2.3 psia, or a pressure of a liquid sorbent mixture that includes water at 55° C. may be reduced down to less than or equal to about 2 psia. Additionally or alternatively, the generated bubbles may only provide for liquid mixing.

A pressure of the liquid sorbent mixture and/or a temperature of the liquid sorbent mixture downstream of stripper 408 may be controlled to drive a vapor phase through the membrane of stripper 408 or condense downstream of stripper 408 and prior to pump 436. The produced bubbles may either go out through the membrane of stripper 408 into the vacuum, thereby carrying carbon dioxide or other contaminants along, or recondense after going through heat exchanger 432 and cooler 440 prior to pump 436 to reduce or prevent cavitation damage. In addition to improving contaminant removal, a reduced pressure in stripper 408 may reduce leakage, as a liquid sorbent side of stripper 408 may be at a pressure closer to a vacuum side.

The metering valve or other pressure reduction device may be controlled to maintain a pressure of a liquid sorbent side of stripper 408 at a desired set-point, such as a setpoint that avoids cavitation at pump 436. Heater 434 may operate to maintain a temperature of the liquid sorbent due to increased removal of water from the liquid sorbent mixture, and compressor 446 may operate to pressurize an increased flow rate of contaminant stream 442 due to increased water vapor.

In the example of FIG. 4, contaminant removal system 400 may include one or more systems or components configured to further process contaminant stream 442. In some examples, contaminant removal system 400 includes a filter 444, a compressor 446, a condenser 448, and a water separator 450 configured to compress contaminant stream 442 and remove water from the compressed contaminant stream 442. For example, for carbon dioxide removed from contaminant removal system 400 to be stored or recycled, compressor 446, condenser 448, and water separator 450 may compress contaminant stream 442 to a high pressure and remove nearly all water from contaminant stream 442. In a life support application, a large amount of water may be present in cabin air stream 410. Sabatier reactor 454 may be configured to generate one or more hydrocarbons using the removed carbon dioxide, and may require a water concentration of less than 2% to react hydrogen gas with carbon dioxide.

Filter 444 is configured to remove any leaked liquid sorbent and/or further filter clean contaminants from contaminant stream 442. Compressor 446 is configured to compress contaminant stream 442. A variety of compressors may be used for compressor 446 including, but not limited to, centrifugal compressors, positive displacement compressors, and the like. Condenser 448 may be configured to cool contaminant stream 442 and condense water from contaminant stream 442. For example, condenser 448 may be coupled to a refrigeration system or other cooling system that circulates a cooling medium to cool contaminant stream 442. A variety of condensers may be used for condenser 448 including, but not limited to, shell and tube heat exchangers, plate-fin, surface coolers, heat pipes, thermoelectric devices, cooling jackets, and the like. Water separator 450 may be configured to remove water from contaminant stream 442, discharge a dehumidified contaminant stream 452 to Sabatier reactor 454, and discharge water condensate stream 456 to water storage 458. A variety of water separators may be used for water separator 450 including, but not limited to, static phase separators, capillary phase separator, membrane phase separators, centrifugal/rotary separators, and the like.

A controller (not shown) may be communicatively coupled to and configured to receive measurement signals from one or more sensor sets, and other process control components (not shown) of contaminant removal system 400, such as: control valves for cabin air stream 410, dehumidified air stream 420, decontaminated air stream 422, rehumidified air stream 424, contaminant stream 442, and inlets/outlets to heat exchanger 432, heater 434, liquid sorbent storage 438, and cooler 440; pump 436; blower 414, compressor 446 (e.g., pumping speed); and the like.

The controller may be further configured to operate bubbler 428 to improve mass transfer of contaminants from dehumidified air stream 420 into the liquid sorbent in scrubber 406. For example, the controller may be configured to send control signals to bubbler control valve 418 to control a flow rate of bubbler air stream to bubbler 428. The flow rate of bubbler air stream may correspond to an amount and/or size of bubbles generated by bubbler 428.
Example 1: A liquid sorbent system includes a membrane contactor configured to absorb one or more contaminants into or desorb one or more contaminants from a liquid sorbent, wherein the membrane contactor comprises: a contactor housing configured to receive the liquid sorbent at a liquid inlet and discharge liquid sorbent at a liquid outlet; and one or more hollow fiber membranes positioned in the contactor housing; and a bubbler configured to generate bubbles in the liquid sorbent upstream of the liquid outlet.
Example 2: The liquid sorbent system of example 1, wherein the membrane contactor is a scrubber configured to absorb the one or more contaminants from a gas stream into the liquid sorbent, and wherein the bubbler is configured to discharge at least a portion of the gas stream into the liquid sorbent to generate the bubbles.
Example 3: The liquid sorbent system of any of examples 1 and 2, wherein the membrane contactor is a stripper configured to desorb the one or more contaminants from the liquid sorbent into a contaminant stream, and wherein the bubbler is configured to discharge at least a portion of a gas stream into the liquid sorbent to generate the bubbles.
Example 4: The liquid sorbent system of any of examples 1 through 3, wherein the bubbler includes a sparger configured to generate the bubbles to increase mixing of the liquid sorbent in the one or more hollow fiber membranes of the membrane contactor.
Example 5: The liquid sorbent system of example 4, wherein at least the sparger of the bubbler is positioned within the contactor housing.
Example 6: The liquid sorbent system of any of examples 4 and 5, wherein the sparger of the bubbler is positioned upstream of the liquid inlet of the membrane contactor.
Example 7: The liquid sorbent system of any of examples 4 through 6, wherein the sparger is a porous sparger, and wherein the bubbler further comprises a gas stream junction configured to fluidically couple a bubbler gas stream to the porous sparger.
Example 8: The liquid sorbent system of any of examples 1 through 7, wherein the liquid sorbent system is a contaminant removal system includes a scrubber configured to absorb the one or more contaminants from a gas stream into the liquid sorbent; and a stripper configured to desorb the one or more contaminants from the liquid sorbent into a contaminant stream, and wherein at least one of the scrubber or the stripper comprises the membrane contactor.
Example 9: The liquid sorbent system of example 8, wherein the gas stream comprises a cabin air stream.
Example 10: The liquid sorbent system of any of examples 8 and 9, further comprising a degasser configured to remove bubbles from downstream of the scrubber and upstream of the stripper.
Example 11: A method for absorbing one or more contaminants into or desorbing one or more contaminants from a liquid sorbent includes flowing, by a membrane contactor, the liquid sorbent through one or more hollow fiber membranes, wherein the membrane contactor comprises: a contactor housing configured to receive the liquid sorbent at a liquid inlet and discharge liquid sorbent at a liquid outlet; and the one or more hollow fiber membranes positioned in the contactor housing; and generating, by a bubbler, bubbles in the liquid sorbent upstream of the liquid outlet.
Example 12: The method of example 11, wherein the membrane contactor is a scrubber configured to absorb the one or more contaminants from a cabin air stream into the liquid sorbent, and wherein the bubbler is configured to discharge at least a portion of the cabin air stream into the liquid sorbent to generate the bubbles.
Example 13: The method of any of examples 11 and 12, wherein the membrane contactor is a stripper configured to desorb the one or more contaminants from the liquid sorbent into a contaminant stream, and wherein the bubbler is configured to discharge at least a portion of a gas stream into the liquid sorbent to generate the bubbles.
Example 14: The method of any of examples 11 through 13, wherein the bubbler includes a sparger configured to generate the bubbles to increase mixing of the liquid sorbent in the membrane contactor.
Example 15: The method of example 14, wherein at least the sparger of the bubbler is positioned within the contactor housing.
Example 16: The method of any of examples 14 and 15, wherein the sparger of the bubbler is positioned upstream of the liquid inlet of the membrane contactor.
Example 17: The method of any of examples 14 through 16, wherein the sparger is a porous sparger, and wherein the bubbler further comprises a gas stream junction configured to fluidically couple a bubbler gas stream to the porous sparger.
Example 18: The method of any of examples 11 through 17, wherein the method further comprises: absorbing, by a scrubber, the one or more contaminants from a gas stream into the liquid sorbent; and desorbing, by a stripper, the one or more contaminants from the liquid sorbent into a contaminant stream.
Example 19: The method of example 18, wherein the gas stream comprises a cabin air stream.
Example 20: The method of any of examples 18 and 19, further comprising degassing, by a degasser, at least a portion of the bubbles downstream of the scrubber and upstream of the stripper.

Various examples have been described. These and other examples are within the scope of the following claims.

What is claimed is:

1. A liquid sorbent system, comprising:
a membrane contactor configured to absorb one or more contaminants into or desorb one or more contaminants from a liquid sorbent, wherein the membrane contactor comprises:
a contactor housing configured to receive the liquid sorbent at a liquid inlet and discharge liquid sorbent at a liquid outlet; and
one or more hollow fiber membranes positioned in the contactor housing; and
a bubbler configured to generate bubbles in the liquid sorbent upstream of the liquid outlet.

2. The liquid sorbent system of claim 1,
wherein the membrane contactor is a scrubber configured to absorb the one or more contaminants from a gas stream into the liquid sorbent, and
wherein the bubbler is configured to discharge at least a portion of the gas stream into the liquid sorbent to generate the bubbles.

3. The liquid sorbent system of claim 1,
wherein the membrane contactor is a stripper configured to desorb the one or more contaminants from the liquid sorbent into a contaminant stream, and
wherein the bubbler is configured to discharge at least a portion of a gas stream into the liquid sorbent to generate the bubbles.

4. The liquid sorbent system of claim 1, wherein the bubbler includes a sparger configured to generate the bubbles to increase mixing of the liquid sorbent in the one or more hollow fiber membranes of the membrane contactor.

5. The liquid sorbent system of claim 4, wherein at least the sparger of the bubbler is positioned within the contactor housing.

6. The liquid sorbent system of claim 4, wherein the sparger of the bubbler is positioned upstream of the liquid inlet of the membrane contactor.

7. The liquid sorbent system of claim 4,
wherein the sparger is a porous sparger, and
wherein the bubbler further comprises a gas stream junction configured to fluidically couple a bubbler gas stream to the porous sparger.

8. The liquid sorbent system of claim 1,
wherein the liquid sorbent system is a contaminant removal system comprising:
a scrubber configured to absorb the one or more contaminants from a gas stream into the liquid sorbent; and
a stripper configured to desorb the one or more contaminants from the liquid sorbent into a contaminant stream, and
wherein at least one of the scrubber or the stripper comprises the membrane contactor.

9. The liquid sorbent system of claim 8, wherein the gas stream comprises a cabin air stream.

10. The liquid sorbent system of claim 8, further comprising a degasser configured to remove bubbles from downstream of the scrubber and upstream of the stripper.

11. A method for absorbing one or more contaminants into or desorbing one or more contaminants from a liquid sorbent, comprising:
flowing, by a membrane contactor, the liquid sorbent through one or more hollow fiber membranes, wherein the membrane contactor comprises:
a contactor housing configured to receive the liquid sorbent at a liquid inlet and discharge liquid sorbent at a liquid outlet; and
the one or more hollow fiber membranes positioned in the contactor housing; and
generating, by a bubbler, bubbles in the liquid sorbent upstream of the liquid outlet.

12. The method of claim 11,
wherein the membrane contactor is a scrubber configured to absorb the one or more contaminants from a cabin air stream into the liquid sorbent, and
wherein the bubbler is configured to discharge at least a portion of the cabin air stream into the liquid sorbent to generate the bubbles.

13. The method of claim 11,
wherein the membrane contactor is a stripper configured to desorb the one or more contaminants from the liquid sorbent into a contaminant stream, and
wherein the bubbler is configured to discharge at least a portion of a gas stream into the liquid sorbent to generate the bubbles.

14. The method of claim 11, wherein the bubbler includes a sparger configured to generate the bubbles to increase mixing of the liquid sorbent in the membrane contactor.

15. The method of claim 14, wherein at least the sparger of the bubbler is positioned within the contactor housing.

16. The method of claim 14, wherein the sparger of the bubbler is positioned upstream of the liquid inlet of the membrane contactor.

17. The method of claim 14,
wherein the sparger is a porous sparger, and
wherein the bubbler further comprises a gas stream junction configured to fluidically couple a bubbler gas stream to the porous sparger.

18. The method of claim 11, wherein the method further comprises:
absorbing, by a scrubber, the one or more contaminants from a gas stream into the liquid sorbent; and
desorbing, by a stripper, the one or more contaminants from the liquid sorbent into a contaminant stream.

19. The method of claim 18, wherein the gas stream comprises a cabin air stream.

20. The method of claim 18, further comprising degassing, by a degasser, at least a portion of the bubbles downstream of the scrubber and upstream of the stripper.
